(19) United States
(12) Patent Application Publication
(10) Pub. No.: US 2017/0177712 A1
(43) Pub. Date: Jun. 22, 2017

(54) SINGLE STEP CROSS-LINGUISTIC SEARCH USING SEMANTIC MEANING VECTORS

(71) Applicant: eBay Inc., San Jose, CA (US)

(72) Inventors: Selcuk Kopru, San Jose, CA (US); Mingkuan Liu, San Jose, CA (US); Evgeny Matusov, Aachen (DE); Hassan Sawaf, Los Gatos, CA (US)

(21) Appl. No.: 15/179,314

(22) Filed: Jun. 10, 2016

Related U.S. Application Data
(60) Provisional application No. 62/270,489, filed on Dec. 21, 2015.
(60) Provisional application No. 62/293,922, filed on Feb. 11, 2016.
(60) Provisional application No. 62/294,060, filed on Feb. 11, 2016.

(51) Int. Cl. G06F 17/30; G06F 17/27; G06F 17/28

(52) U.S. Cl. CPC G06F 17/30684; G06F 17/30669; G06F 17/289; G06F 17/2809; G06F 17/2785

(57) ABSTRACT

System and methods for clustering courses based on recorded member records are disclosed. The server system receives a search query in a first language. The server system generates a semantic meaning vector associated with the search query. The server system accesses a plurality of semantic meaning vectors associated with item records, wherein at least some of the item records are not written in the first language. For each respective semantic meaning vector associated with item records, the server system compares the semantic meaning vector with the semantic meaning vector associated with the search query and selects item records based on the comparison. For each selected item record the server system determines whether the item record is written in the first language and if so, automatically translates the item record into the first language. The server system transmits the one or more selected item records to the client system for display.

### CROSS-REFERENCE TO RELATED APPLICATIONS

This application claims the benefit of priority to U.S. Provisional Application Ser. No. 62/270,489, filed on Dec. 21, 2015; U.S. Provisional Application Ser. No. 62/293,922, filed on Feb. 11, 2016; and U.S. Provisional Application Ser. No. 62/294,060 filed on Feb. 11, 2016; which applications are incorporated herein by reference in their entirety.

### TECHNICAL FIELD

Embodiments of the present disclosure relate generally to cross-linguistic online search and, more particularly, but not by way of limitation, to improving real-time machine translation for cross border search uses.

### BACKGROUND

The rise in electronic and digital device technology has rapidly changed the way society interacts with media and consumes goods and services. Digital technology enables people to contact each other quickly and efficiently over country and continental boundaries. However, often, despite the ease of contact, language differences prevent uses from effectively interacting. One such area is the area of search and commerce.

One solution to the language barrier is automatic machine translations of communications, searches, product listings, and so on. However, such translations cane be resource intensive and often provide relatively poor translation results.

### BRIEF DESCRIPTION OF THE DRAWINGS

Various ones of the appended drawings merely illustrate example embodiments of the present disclosure and cannot be considered as limiting its scope.

FIG. 1 is a network diagram depicting a client-server system environment that includes various functional components of a network-based commerce system, in accordance with some example embodiments.

FIG. 2 is a block diagram further illustrating the client system, in accordance with some example embodiments.

FIG. 3 is a block diagram further illustrating the network-based commerce system, in accordance with some example embodiments.

FIG. 4 depicts a block diagram of a multi-language search system in accordance with some example embodiments.

FIG. 5 is a flow diagram illustrating a method, in accordance with some example embodiments, for using semantic meaning vectors to perform single step search and translation.

FIGS. 6A-6C are flow diagrams illustrating a method, in accordance with some example embodiments, for using semantic meaning vectors to perform single step search and translation.

FIG. 7 is a block diagram illustrating an example of a software architecture that may be installed on a machine, according to some example embodiments.

FIG. 8 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative example embodiments of the disclosed subject matter. In the following description, for the purposes of explanation, numerous specific details are set forth in order to provide an understanding of various example embodiments of the disclosed subject matter. It will be evident, however, to those skilled in the art, that embodiments of the inventive subject matter may be practiced without these specific details. In general, well-known instruction instances, protocols, structures, and techniques are not necessarily shown in detail.

A network-based commerce system allows users to purchase goods and services over a computer network. These goods and services are often available to people in many countries using many different languages. In a network-based commerce system that sells a plurality of products and services, users can traverse the system using search queries to find what they are looking for.

However, if the language of the user differs from the language a product or service description uses, translation of the search query and description is needed. For example, the system could first translate the search query into the desired language, execute a search of item records in that language using the translated search query, and then translate the item records (e.g., product listings) into the user's original language for display. Such a system involves multiple translation steps, each one introducing additional complexity into the system.

Instead, the network-based commerce system receives a search query in a first language. Instead of translating the query into another language, the network-based commerce system instead converts the search query into a semantic meaning vector.

Each semantic meaning vector is made of a plurality of values that represent one or more attributes of the search query. The conversion is accomplished by an established model, which has been trained using artificial intelligence techniques (e.g., neural networks and so on) and past user data to create a model that accurately creates semantic meaning vectors from search queries.

In some example embodiments, when a product is listed in network-based commerce system, the network-based commerce system converts each item record into a semantic meaning vector using the trained model and stores it in a database of semantic meaning vectors at the network-based commerce system regardless of the original language of the item record.

Thus, when a search query is received, it is converted into a semantic meaning vector and compared against the database of item records associated semantic meaning vectors. The network-based commerce system then scores or otherwise ranks each semantic meaning vector associated with an item record based on the degree to which it matches the semantic meaning vector for the search query. In some example embodiments, a distance score can be calculated.

In some example embodiments, the database of semantic meaning vectors associated with item records is organized into one or more topical groupings and the network-based commerce system selects only one topical grouping to compare the search query against (to prevent too many unnecessary calculations). The semantic meaning vector associated with the search query is only compared to a limited set of semantic meaning vectors associated with item records.

Once one or more item records have been identified as the best matches for the search query (based on comparing the semantic meaning vectors for each), the network-based commerce system determines whether the item records use the same language as the search query. For any item record determined to have a different language than the search query, the network-based commerce system translates the item record into the appropriate language.

All the item records are then transmitted to the client (e.g., a computer system associated with the user who submitted the search query) for display. In some example embodiments, the user selects and purchases one of the returned results. In some example embodiments, this purchase event is then used to further improve the model that creates semantic meaning vectors for search queries and item records.

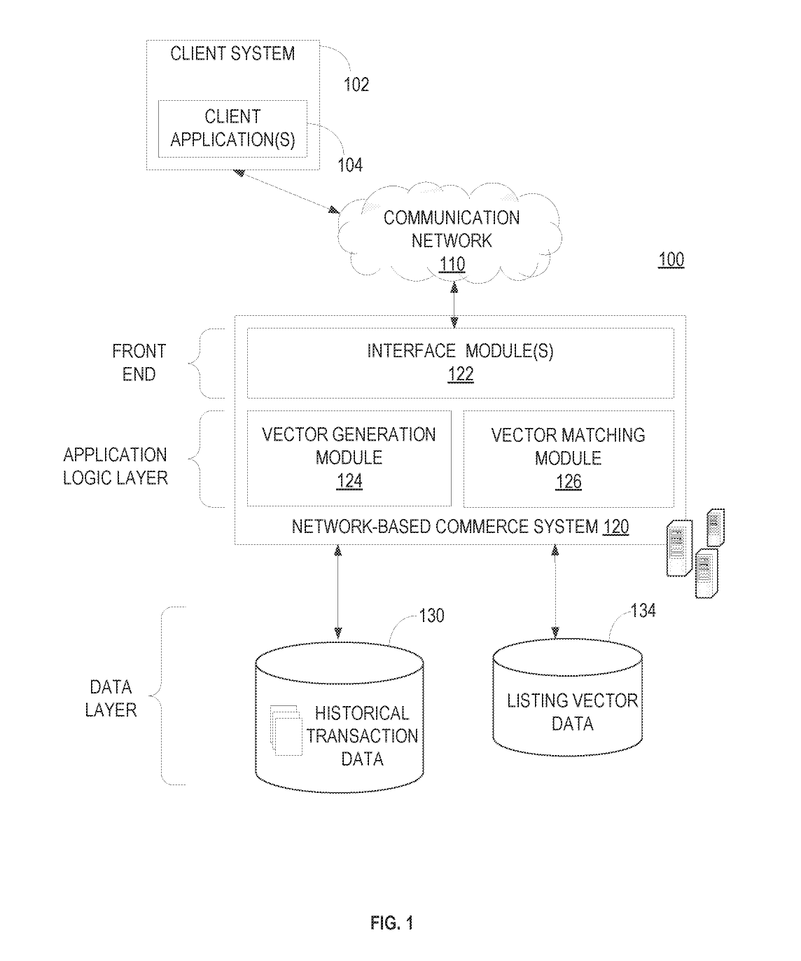

FIG. 1 is a network diagram depicting a client-server system environment 100 that includes various functional components of a network-based commerce system 120, in accordance with some example embodiments. The client-server system environment 100 includes at least a client system 102 and a network-based commerce system 120. One or more communication networks 110 interconnect these components. The communication networks 110 may be any of a variety of network types, including local area networks (LANs), wide area networks (WANs), wireless networks, wired networks, the Internet, personal area networks (PANs), or a combination of such networks.

In some example embodiments, a client system 102 is an electronic device, such as a personal computer (PC), a laptop, a smartphone, a tablet, a mobile phone, or any other electronic device capable of communication with a communication network 110. The client system 102 includes one or more client application(s) 104, which are executed by the client system 102. In some example embodiments, the client application(s) 104 include one or more applications from a set consisting of search applications, communication applications, productivity applications, game applications, word processing applications, or any other useful applications. The client application(s) 104 include a web browser. The client system 102 uses a web browser to send and receive requests to and from the network-based commerce system 120 and displays information received from the network-based commerce system 120.

In some example embodiments, the client system 102 includes an application specifically customized for communication with the network-based commerce system 120 (e.g., an iPhone application). In some example embodiments, the network-based commerce system 120 is a system that is associated with one or more services.

In some example embodiments, the client system 102 sends a request to the network-based commerce system 120 for a webpage associated with the network-based commerce system 120. For example, a user uses a client system 102 to log into the network-based commerce system 120 and submits a search query to the network-based commerce system 120. In response, the network-based commerce system 120 generates a list of search results (e.g., one or more item records matching the search query) and returns item record to the client system 102. The client system 102 receives the item record data (e.g., data describing one or more products) and displays that data in a user interface on the client system 102.

In some example embodiments, as shown in FIG. 1, the network-based commerce system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding of the various example embodiments have been omitted from FIG. 1. However, a skilled artisan will readily recognize that various additional functional modules and engines may be used with the network-based commerce system 120, such as that illustrated in FIG. 1, to facilitate additional functionality that is not specifically described herein. Furthermore, the various functional modules and engines depicted in FIG. 1 may reside on a single server computer or may be distributed across several server computers in various arrangements. Moreover, although depicted in FIG. 1 as a three-tiered architecture, the various example embodiments are by no means limited to this architecture.

As shown in FIG. 1, the front end consists of an interface module(s) (e.g., a web server) 122, which receives searches from various client systems 102 and communicates the search results to the appropriate client system 102. In some example embodiments, the interface module(s) 122 implements a single application programmatic interface (API) which all client systems 102 use to send search queries and receive search results.

As shown in FIG. 1, the data layer includes several databases, including databases for storing various data for users of the network-based commerce system 120, including historical transaction data 130 and listing vector data 134.

In some example embodiments, the historical transaction data 130 includes data that describes past user purchases, the search queries that users have entered to initiate the purchase, the search results that were displayed to the user, and any other data relevant to a particular transaction. In some example embodiments, the network-based commerce system 120 uses the historical transaction data 130 to develop a model for creating semantic meaning vectors from item records and search queries. In some example embodiments, the historical transaction data 130 also includes the language of each search query and item records to allow the network-based commerce system 120 to associate search queries with item records of difference languages.

In some example embodiments, the listing vector data 134 includes a database of semantic meaning vectors that are each associated with a particular item record. In some example embodiments, the semantic meaning vector includes a series of values (e.g., potentially hundreds of values) generated by a computer learning model. In some example embodiments, the database is organized based on that is used to respond to user search queries (e.g., an index that is used to look up search results) and data that represents past search queries and any user interactions (e.g., user clicks) that resulted after the search results are displayed. Thus, the network-based commerce system 120 can use the data stored about search results to identify which search terms result in clicks on particular item records and purchases.

In some example embodiments, the listing vector data 134 is organized into categories, groups, product classes, and so on. In this way, the network-based commerce system 120 can restrict a search to a particular product category to increase efficiency.

The network-based commerce system 120 may provide a broad range of other applications and services that allow users the opportunity to buy and sell items, share and receive information, often customized to the interests of the user, and so on.

In some example embodiments, the application logic layer includes various application server modules, which, in conjunction with the interface module(s) 122, receive user search queries from a large variety of client systems (102) and return search results to those client systems 102.

In some example embodiments, a vector generation module 124 and a vector matching module 126 can also be included in the application logic layer. Of course, other applications or services that utilize the vector generation module 124 and the vector matching module 126 may be separately implemented in their own application server modules.

As illustrated in FIG. 1, with some example embodiments, the vector generation module 124 and the vector matching module 126 are implemented as services that operate in conjunction with various application server modules. For instance, any number of individual application server modules can invoke the functionality of the vector generation module 124 and the vector matching module 126. However, with various alternative example embodiments, the vector generation module 124 and the vector matching module 126 may be implemented as their own application server modules such that they operate as stand-alone applications.

Generally, the vector generation module 124 receives a search request that includes a search query. In some example embodiments, the vector generation module 124 converts the received search query into a semantic meaning vector. In some example embodiments, the semantic meaning vector is generated based on a model that was trained using historical transaction data 130 to determine common attributes of various item records and search queries. In some example embodiments, as new transactions occur, the vector generation module 124 updates the model to incorporate the new data. In some example embodiments, the model is able to convert item records and search queries of different languages into a common semantic meaning vector, such that they can be compared without regard to their language.

Similarly, when a new item record is received from a client system 102, the vector generation module 124 creates a semantic meaning vector for the item record. The newly created semantic meaning vector is then stored in the listing record vector data 134. In some example embodiments, the vector generation module 124 determines a product category associated with the item record and organizing the associated semantic meaning vector in the listing vector data 134 based on the product category.

In some example embodiments, the listing vector data 134 has an established product category hierarchy and each item record is placed into one or more categories in the hierarchy.

The vector matching module 126 uses a semantic meaning vector created by the vector generation module 124 for a particular search query to find matches for that search query in the listing vector data 134. In some example embodiments, the vector matching module 126 compares the semantic meaning vector of the search query to each semantic meaning vector stored in the listing vector data 134 and generates a match score for each.

In some example embodiments, the vector matching module 126 generates a distance score between the two semantic meaning vectors (wherein a distance score represents the similarity between the two semantic meaning vectors). The vector matching module 126 then ranks each item record semantic meaning vector based on the associated score.

In some example embodiments, the vector matching module 126 determines a particular number of item record results that are desired and selects that number of item record semantic meaning vectors based on rank. For each selected semantic meaning vector, the vector matching module 126 receives the associated item record and, if necessary, translates the item record into the language of the user who submitted the search query (e.g., into the language that the search query used or another language as indicated by the submitting user).

In some example embodiments, the selected item records are then transmitted to the client system 102 for display.

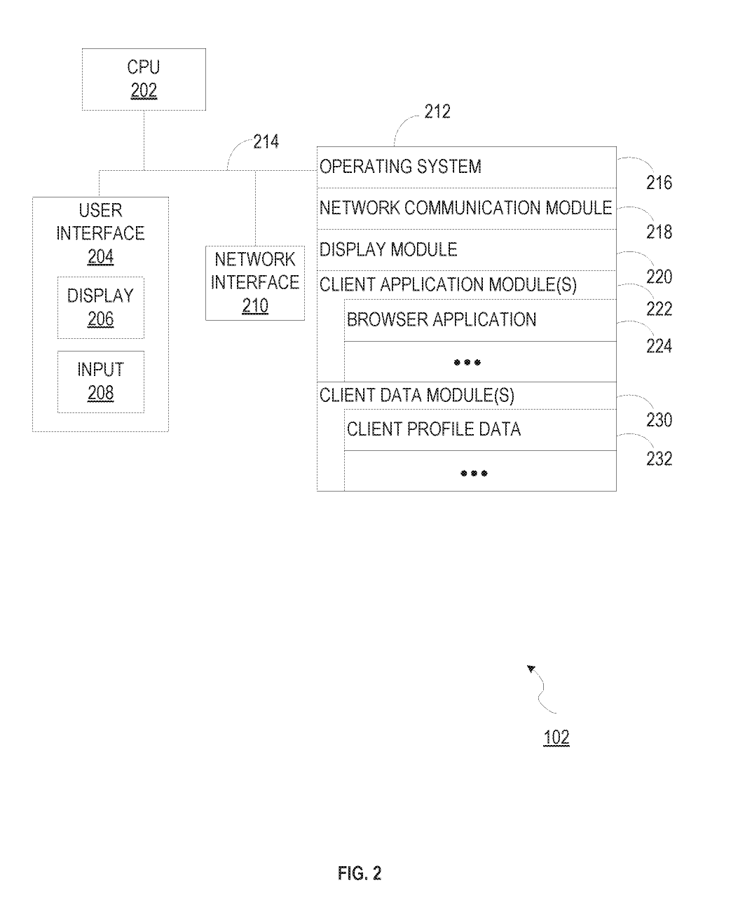

FIG. 2 is a block diagram further illustrating the client system 102, in accordance with some example embodiments. The client system 102 typically includes one or more central processing units (CPUs) 202, one or more network interfaces 210, memory 212, and one or more communication buses 214 for interconnecting these components. The client system 102 includes a user interface 204. The user interface 204 includes a display device 206 and optionally includes an input device 208 such as a keyboard, mouse, touch sensitive display, or other input means. Furthermore, some client systems use a microphone and voice recognition to supplement or replace other input devices.

The memory 212 includes high-speed random access memory, such as dynamic random-access memory (DRAM), static random access memory (SRAM), double data rate random access memory (DDR RAM) or other random access solid state memory devices, and may include non-volatile memory, such as one or more magnetic disk storage devices, optical disk storage devices, flash memory devices, or other non-volatile solid state storage devices. The memory 212 may optionally include one or more storage devices remotely located from the CPU(s) 202. The memory 212, or alternatively, the non-volatile memory device(s) within the memory 212, comprise(s) a non-transitory computer-readable storage medium.

In some example embodiments, the memory 212, or the computer-readable storage medium of the memory 212, stores the following programs, modules, and data structures, or a subset thereof:
an operating system 216 that includes procedures for handling various basic system services and for performing hardware-dependent tasks;
a network communication module 218 that is used for coupling the client system 102 to other computers via the one or more network interfaces 210 (wired or wireless) and one or more communication networks 110, such as the Internet, other WANs, LANs, MANs, etc.;
a display module 220 for enabling the information generated by the operating system 216 and the client application(s) 104 to be presented visually on the display device 206;
one or more client application modules 222 for handling various aspects of interacting with the network-based commerce system (e.g., the system 120 in FIG. 1), including but not limited to:
   a browser application 224 for requesting information from a web service associated with the network-based commerce system 120 (e.g., content items and item records) and receiving responses from the web service associated with the network-based commerce system 120; and
client data module(s) 230 for storing data relevant to the clients, including but not limited to:
   client profile data 232 for storing profile data related to a user of the network-based commerce system 120 associated with the client system 102.

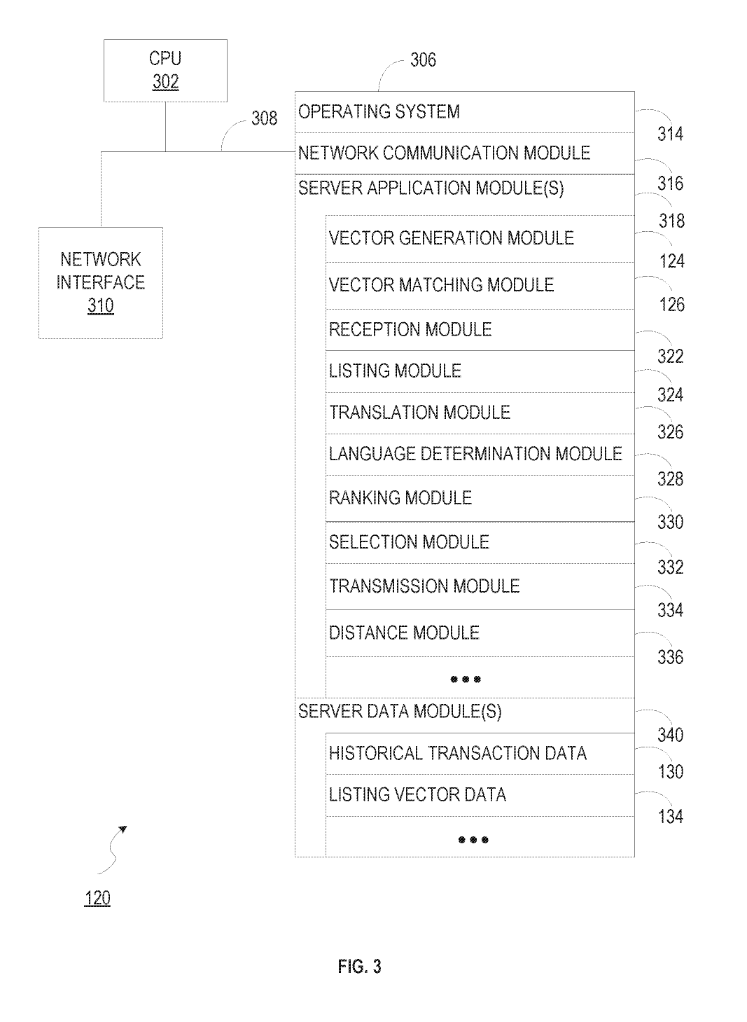

FIG. 3 is a block diagram further illustrating the network-based commerce system 120, in accordance with some example embodiments. The network-based commerce system 120 typically includes one or more CPUs 302, one or more network interfaces 310, memory 306, and one or more communication buses 308 for interconnecting these components. The memory 306 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. The memory 306 may optionally include one or more storage devices remotely located from the CPU(s) 302.

The memory 306, or alternately the non-volatile memory device(s) within the memory 306, comprises a non-transitory computer-readable storage medium. In some example embodiments, the memory 306, or the computer-readable storage medium of the memory 306, stores the following programs, modules, and data structures, or a subset thereof:
an operating system 314 that includes procedures for handling various basic system services and for performing hardware-dependent tasks;
a network communication module 316 that is used for coupling the network-based commerce system 120 to other computers via the one or more network interfaces 310 (wired or wireless) and one or more communication networks 110, such as the Internet, other WANs, LANs, MANs, and so on;
one or more server application modules 318 configured to perform the services offered by the network-based commerce system 120, including but not limited to:
   a vector generation module 124 for converting search queries and item records into semantic meaning vectors, training a vector generation model based on historical transaction data 130, and receiving item records and search queries from client systems (e.g., the client system 102 in FIG. 1);
   a vector matching module 126 for comparing a semantic meaning vector associated with a received search query to a plurality of semantic meaning vectors associated with item records stored in listing vector data 134 and selecting the best matching item records based on this comparison;
   a reception module 322 for receiving search queries and item records from users via client system (e.g., the client system 102 in FIG. 1);
   an listing module 324 for creating item records based on information submitted from users in order to sell a product via the network-based commerce system 120;
   a translation module 326 for automatically translating item record from a first language to a second language;
   a language determination module 328 for determining whether the language in an item record is the same as the language of a submitted search query;
   a ranking module 330 for ranking each semantic meaning vector for item records based on the degree to which they match a semantic meaning vector for a search query;
   a selection module 332 for selecting one or more item records based on the ranking of semantic meaning vector associated with each item record;
   a transmission module 334 for transmitting selected item records to a client system (e.g., the client system 102 in FIG. 1) for display; and
   a distance module 336 for determining similarity between two semantic meaning vectors based on a calculation which determines a distance between the two vectors; and
server data module(s) 340, storing data related to the network-based commerce system 120, including but not limited to:
   historical transaction data 130, including data describing past interactions (e.g., sales and/bids) and information about those interactions, including the search query that was used to initiate the transaction, the search results that were displayed, and the item records that the user clicked on prior to completing the transaction; and
   listing vector data 134 for storing semantic meaning vector for a plurality of item records to be used when matching a search query in another language.

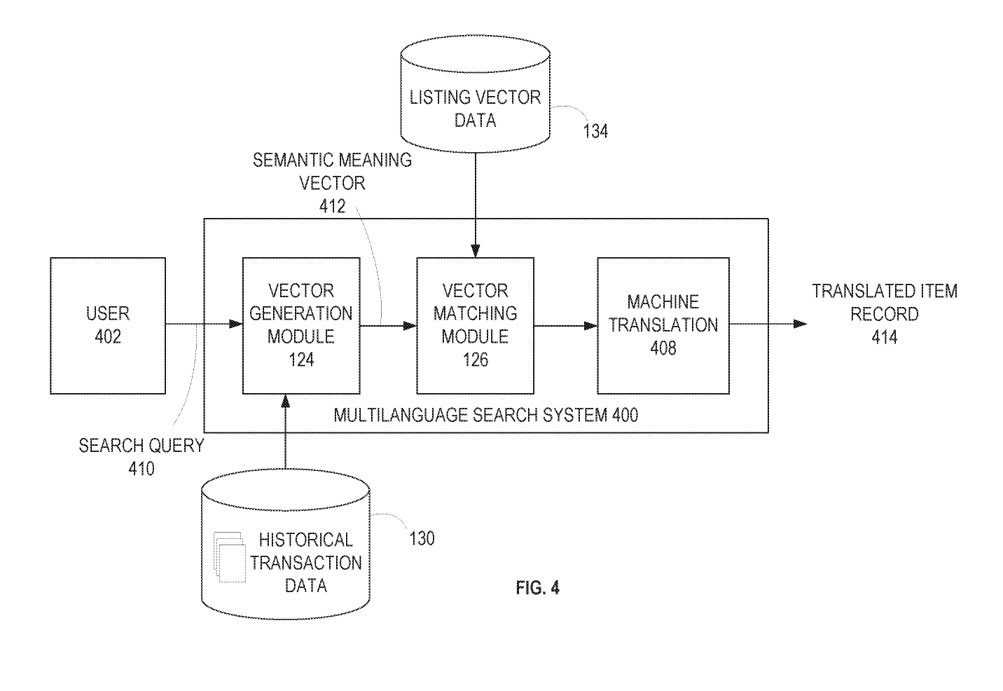

FIG. 4 depicts a block diagram of a multi-language search system 400 in accordance with some example embodiments. In accordance with some example embodiments, a user connects with the multi-language search system 400 via a network. The user submits a search query 410 in a first language.

In some example embodiments, the multi-language search system 400 is a component of the network-based commerce system (e.g., the system 120 in FIG. 1) and receives search queries from users 402. In some example embodiments, a vector generation module 124 receives the search query. Rather than translate the search query to one or more other languages, the vector generation module 124 creates a semantic meaning vector 412 for the search query.

In some example embodiments, the vector generation module 124 includes a model that maps queries to semantic meaning vectors. In some example embodiments, the model is trained using historical transaction data 130. In some example embodiments, the model itself is constructed using computer learning techniques such as decision tree learning, artificial neural networks and deep learning techniques, support vector machines, Bayesian networks, and so on.

For example, the vector generation module 124 identifies all historic transactions between searches in a first language and purchases of item records (e.g., products) in a second language.

In some example embodiments, once the vector generation module 124 creates a semantic meaning vector 412 for the search query 410, the semantic meaning vector 412 is transferred to the vector matching module 126.

In some example embodiments, the vector matching module 126 analyzes a plurality of semantic meaning vectors stored in the listing vector data 134 and associated with one or more item records to identify one or more semantic meaning vectors that match the semantic meaning vector 412 created from the search query 410. In some example embodiments, each semantic meaning vector 412 includes a plurality of values, and the vector matching module 126 creates a score that represents the similarity between a respective semantic meaning vector associated with an item record and the semantic meaning vector 412 associated with the search query 410.

Once all the semantic meaning vectors 412 in the listing vector data 134 have been evaluated, the vector matching module 126 selects one or more semantic meaning vectors 412 from the listing vector data 134 based on the generated scores. The item records associated with the selected semantic meaning vector 412 are then transmitted to the machine translation 408 module. In some example embodiments, the machine translation 408 module determines which, if any, of the selected item records are in a language different from the language associated with the search query 410.

If any of the selected item records are determined to be in a different language than the search query 410, the machine translation 408 module automatically translates the item records from their original language (e.g., the language in which they were submitted) to the language of the search query 410. The translated item records 414 are then transmitted to the client system (e.g., the client system 102 in FIG. 1).

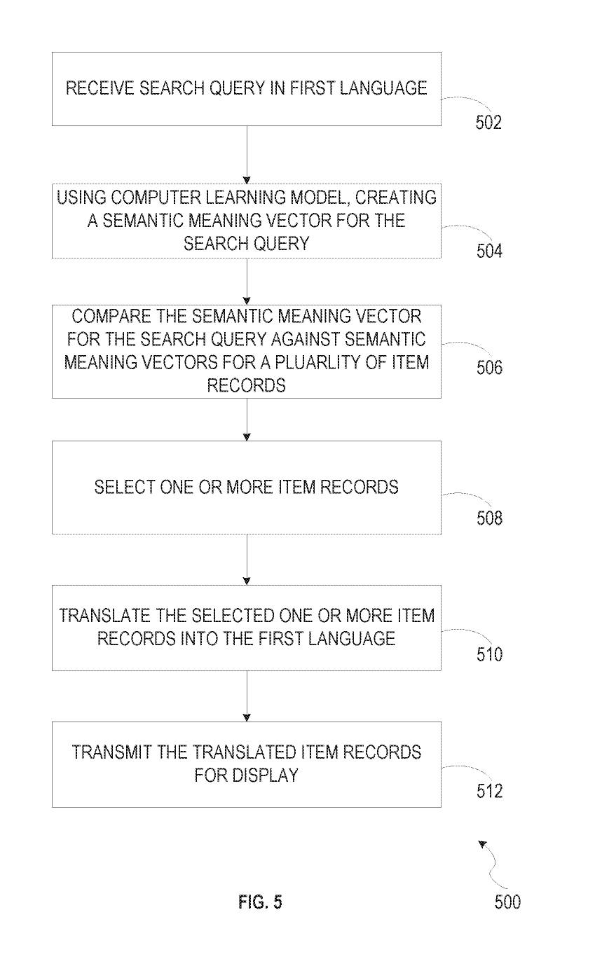

FIG. 5 is a flow diagram illustrating a method 500, in accordance with some example embodiments, for using semantic meaning vectors to perform single step search and translation. Each of the operations shown in FIG. 5 may correspond to instructions stored in a computer memory or computer-readable storage medium. In some embodiments, the method 500 described in FIG. 5 is performed by the network-based commerce system (e.g., the system 120 in FIG. 1). However, the method 500 can also be performed by any other suitable configuration of electronic hardware.

In some embodiments the method 500 is performed at a network-based commerce system (e.g., the system 120 in FIG. 1) including one or more processors and memory storing one or more programs for execution by the one or more processors.

In some example embodiments, the network-based commerce system (e.g., the system 120 in FIG. 1) receives (502) a search query (e.g., search query 410) from a client system (e.g., the client system 102 in FIG. 1). The search query has an associated first language (e.g., the language the search query is written in).

In some example embodiments, the network-based commerce system (e.g., the system 120 in FIG. 1) uses a computer learning model to create a model based on past purchase data. In some example embodiments, the model is created using a deep learning or neural network learning method. In some example embodiments, the network-based commerce system (e.g., the system 120 in FIG. 1) creates (504) a semantic meaning vector (e.g., semantic meaning vector 412) associated with the search query using the model. For example, the network-based commerce system (e.g., the system 120 in FIG. 1) has created a model that uses the text of a search query to generate a semantic meaning vector. The semantic meaning vector is a series of numbers that represent the location (e.g., where location is based on the semantic meaning) of the search query or item record in a multi-dimensional vector space.

In a very simplified example, for a two dimensional space, with (x,y) values that range from 0 to 1, a model is trained to represent different areas in the 2-dimensional space with different semantic meanings. Each item record and search query could then be mapped to a specific (x,y) pair by the model. The network-based commerce system (e.g., the system 120 in FIG. 1) then determines the similarity between a search query and an item record by calculating the distance between the two points in (x,y) space.

In general, the semantic meaning vector will be mapped into a vector with hundreds of dimensions, such that very complicated semantic meanings can be represented by the model.

In some example embodiments, the model uses the entire corpus of past search queries and the item records associated with the purchases that they resulted in to identify semantic relationships between queries and item records. In some example embodiments, the relationships can be based on frequency co-occurrence of terms (e.g., with a large enough body of documents, determining which terms occur in the same documents can enable a model to effectively generate semantic meaning vectors. In some example embodiments, the important of terms is weighted by an inverse frequency score.

In other example embodiments, a model is trained by determining semantic correlations using a neural network. In this example, the neural network takes inputs (e.g., various data about the search query or item record including the text, time sent, location source, and so on). Each of these inputs is given a weight and passed to a plurality of hidden nodes. The hidden nodes exchange information, also given weights, to produce an output. In some example embodiments, there are several layers of hidden nodes. The output in this case is a multidimensional vector. For example, a first semantic meaning vector would include a list of values in smv₁=(v₁, v₂, v₃, v₄, . . . , vₙ).

In some example embodiments, the model is trained using existing data (e.g., search queries matched to successful purchases) and the neural network learning algorithm adaptively adjusts the weights to product semantic meaning vectors for queries and item records that match existing records. In some example embodiments, when new transactions occur, the model is updated with the new data.

In some example embodiments, the semantic meaning vector also uses other variables to create the semantic meaning vector for the search query including characteristics and history of the submitting user, time and location of the search query, and so on.

Once the semantic meaning vector has been generated for the search query, the network-based commerce system (e.g., the system 120 in FIG. 1) compares (506) the semantic meaning vector for the search query against semantic meaning vectors associated with a plurality of item records (e.g., each item record has an associated semantic meaning vector stored in a database at the network-based commerce system (e.g., the system 120 in FIG. 1)).

In some example embodiments, the network-based commerce system (e.g., the system 120 in FIG. 1) calculates a similarity score or closeness score between the two semantic meaning vectors. In some example embodiments, the similarity score is an n-dimensional Euclidean distance. In other example embodiments, the score may be calculated using a Chebyshev distance, a Hamming Distance, a Mahalanobis distance, a Manhattan distance, a Minkowski distance, a Haversine distance, or any other appropriate distance calculation.

In some example embodiments, the network-based commerce system (e.g., the system 120 in FIG. 1) selects (508) one or more item records from the plurality of item records stored at the network-based commerce system (e.g., the system 120 in FIG. 1). Item records are selected, at least in part, on the determined similarity or closeness scores for semantic meaning vectors associated with the item records. As noted above, a variety of algorithms can be used to calculate distance between two vectors. One specific example (although, as noted, many different algorithms can be used) of calculating similarity between two vectors with t total vector values is as follows:

$$sim ( query , item {record}_{k} ) = \frac{{\sum }_{j = 1}^{n} {\sum }_{i = 1}^{n} {w}_{i , k} * {w}_{j , query} * {t}_{i} dot {t}_{j}}{\sqrt{{\sum }_{i = 1}^{n} {w}_{i , k}^{2}} * \sqrt{{\sum }_{i = 1}^{n} {w}_{i , query}^{2}}}$$

Thus, the similarly between a query semantic meaning vector and an item record semantic meaning vector with t total vector values. This calculation will result in a value. The lower the value for a query, item record pair, the closer, within the vector space, the query and item record are determined to be.

In some example embodiments, the database of item records includes item records from a plurality of different languages. The semantic meaning vectors standardize meaning between languages. Thus, once one or more item records are determined, the network-based commerce system (e.g., the system 120 in FIG. 1) translates (510), if necessary, the item records into the first language. In this way, the first user can submit a search query in their language and get results for products in other languages.

Once the item records are translated into the appropriate language, the network-based commerce system (e.g., the system 120 in FIG. 1) transmits (512) the translated item records to the client system (e.g., the client system 102 in FIG. 1) for display.

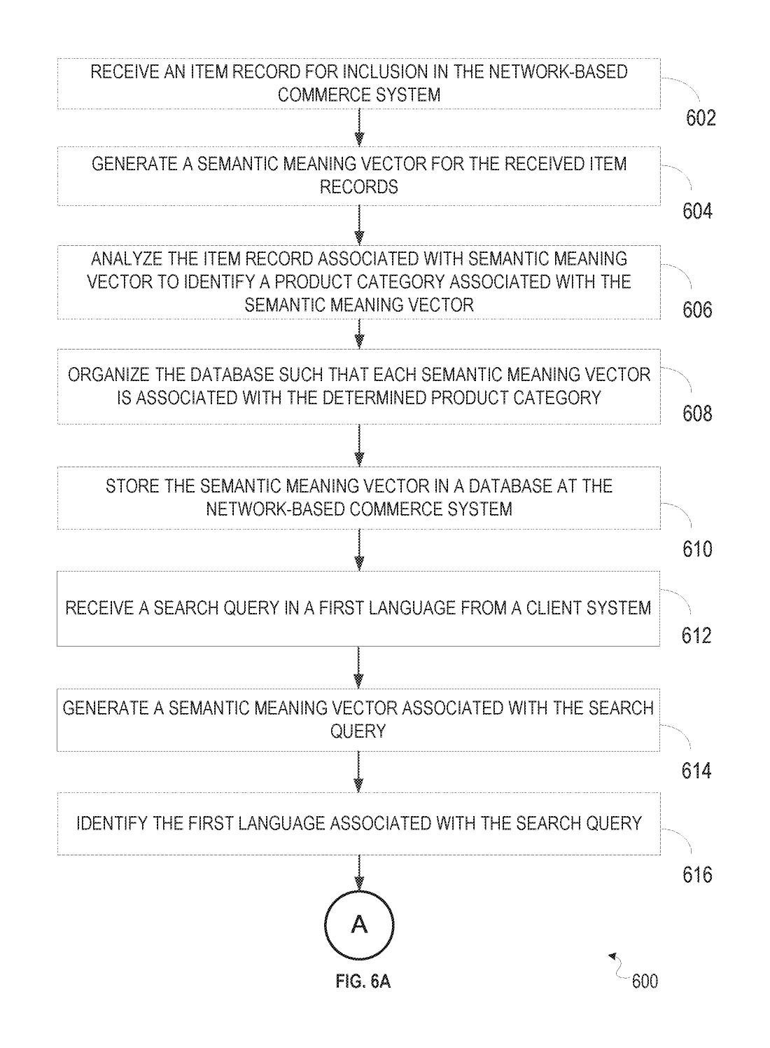

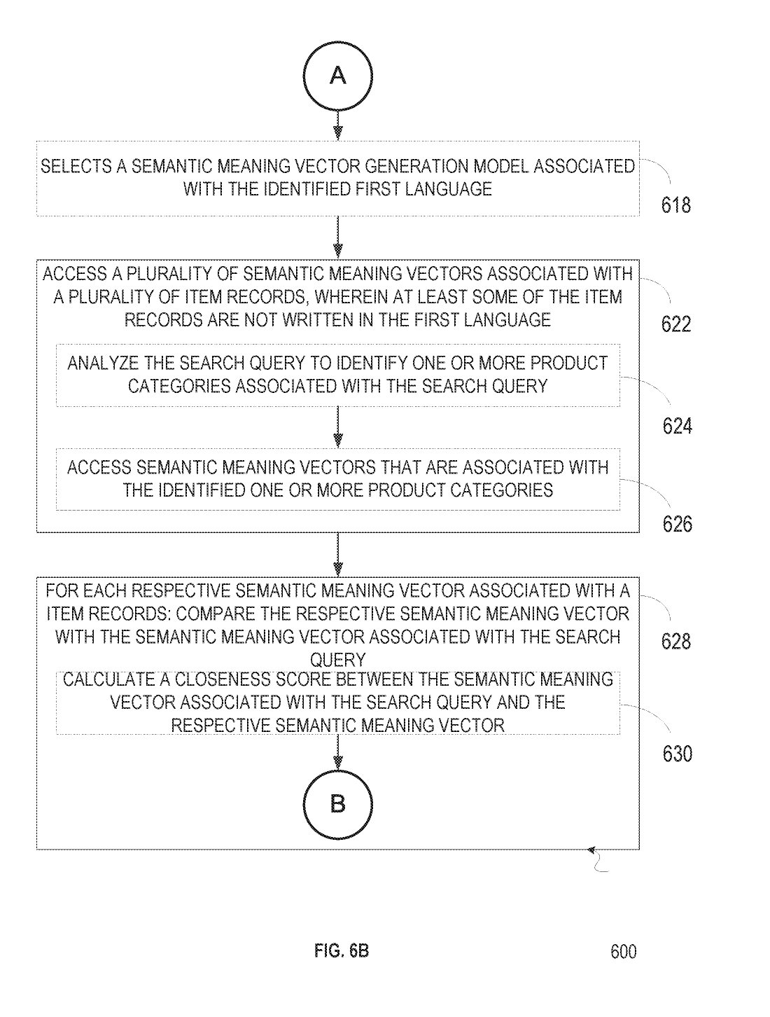

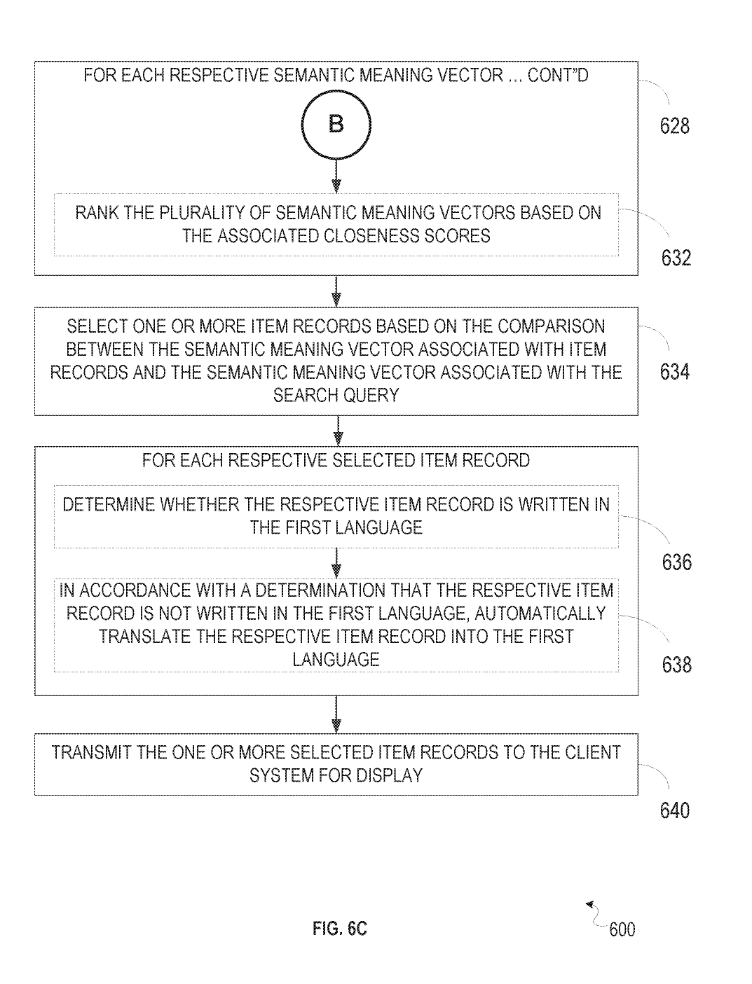

FIG. 6A is a flow diagram illustrating a method, in accordance with some example embodiments, for using semantic meaning vectors to perform single step search and translation. Each of the operations shown in FIG. 6A may correspond to instructions stored in a computer memory or computer-readable storage medium. Optional operations are indicated by dashed lines (e.g., boxes with dashed-line borders). In some embodiments, the method described in FIG. 6A is performed by the network-based commerce system (e.g., the system 120 in FIG. 1). However, the method described can also be performed by any other suitable configuration of electronic hardware.

In some embodiments the method 600 is performed at a network-based commerce system (e.g., the system 120 in FIG. 1) including one or more processors and memory storing one or more programs for execution by the one or more processors.

In some example embodiments, a network-based commerce system (e.g., the system 120 in FIG. 1) receives (602) an item record for inclusion in the network-based commerce system (e.g., the system 120 in FIG. 1). An item record is a description of a product to be sold on the network-based commerce system (e.g., the system 120 in FIG. 1). The description can include a title, product specification and features, an image, and any other pertinent information.

A large network-based commerce system (e.g., the system 120 in FIG. 1) can make its services available to users in a large number of countries such that the users speak a large number of languages. Thus, an item record may be written in virtually any language. To standardize item records, the network-based commerce system (e.g., the system 120 in FIG. 1) generates (604) a semantic meaning vector for the received item records. As noted above, a semantic meaning vector is a series of numbers (or values) that represent characteristics of the item record. In some example embodiments, the network-based commerce system (e.g., the system 120 in FIG. 1) uses past transaction data in conjunction with computer learning techniques (e.g., neural networks) to create a model that will generate semantic meaning vectors for item records and search queries. In some example embodiments, there is a model for each potential language. Thus any item record or search query will be converted to a semantic meaning vector that can be compared regardless of the source language.

As noted above, item records and search queries are converted to semantic meaning vectors by using a model that was trained by any appropriate method (the above example uses neural networks) to use the data associated with either the query or the item record as input and to generate a semantic meaning vector with n-dimensions (often numbering in the hundreds). By using a large set of completed transaction data, wherein at least some of the transactions include searches in a first language that eventually result in completed transactions for items that an item record created in a second language, models can be trained that associate queries in a first language with item records in a second language. Once such a model is produced (e.g., the input weightings and hidden weightings of a neural network are adapted to produce accurate semantic meaning vector using the training data) search queries in the first language can be translated into semantic meaning vectors that can be compared against semantic meaning vectors in a second language without the need to translate either the query or the item record.

In some example embodiments, the network-based commerce system (e.g., the system 120 in FIG. 1) analyzes (606) the item record associated with the semantic meaning vector to identify a product category associated with the semantic meaning vector. For example, if the product is a pair of shoes, the network-based commerce system (e.g., the system 120 in FIG. 1) can categorize the product as footwear. Having a product category associated with each item record and semantic meaning vector allows for search efficiencies, as discussed below.

In some example embodiments, the product category is determined based on an analysis of the search query. For example, the network-based commerce system (e.g., the system 120 in FIG. 1) includes a database of terms and the matching product category. In other example embodiments, the user chooses a specific product category when submitting the search query. In other example embodiments, the first compares the semantic meaning vector for the search queries to a series of semantic meaning vectors that represent a plurality of product categories. The closest match (e.g., using algorithms mentioned above) is determined to be the product category associated with the query.

In some example embodiments, the network-based commerce system (e.g., the system 120 in FIG. 1) organizes (608) the database such that each semantic meaning vector is associated with the determined product category.

In some example embodiments, the network-based commerce system (e.g., the system 120 in FIG. 1) stores (610) the semantic meaning vector in a database at the network-based commerce system (e.g., the system 120 in FIG. 1). Thus, each item record is represented by a semantic meaning vector in a database. In some example embodiments, the database is organized by product.

It should be noted that operations 602-610 describe the processes of creating a database of content item vectors and a model trained to generate semantic meaning vectors for search queries and item content records. These steps can be performed off line at any point before a query that requires the model and database is received. Thus, although the figure shows operation 612 directly following operation 610, there can a large amount of time between these two operations.

Operation 612 is part of a real-time generation of a semantic meaning vector in response to receiving a search query. Thus, the steps represented in operations 602-610 will be accomplished at some point before the real-time semantic meaning vector generation but not necessarily directly beforehand.

In some example embodiments, the network-based commerce system (e.g., the system 120 in FIG. 1) receives (612) a search query in a first language from a client system (e.g., the client system 102 in FIG. 1). In some example embodiments, the user submits the search query as text in their preferred language. In some example embodiments, the network-based commerce system (e.g., the system 120 in FIG. 1) automatically detects the language of the search query based on the text, the location the search query originated from, and characteristics of the user.

In some example embodiments, the network-based commerce system (e.g., the system 120 in FIG. 1) generates (614) a semantic meaning vector associated with the search query. As noted above, the network-based commerce system (e.g., the system 120 in FIG. 1) uses a model which is trained using a machine learning algorithm such as a neural network. The training uses historical data from the network-based commerce system (e.g., the system 120 in FIG. 1) (such as purchases and clicks and the search queries that initiated those interactions). In some example embodiments, each language uses a language-specific model to generate semantic meaning vectors.

In other example embodiments, a distinct model is used for each source language/target language pairing. Thus, if three languages are supported (Language A, Language B, and Language C), there could be six models (e.g., one model to match Language A queries to Language B item records, one to match Language A queries to Language C item records, one to match Language B queries to Language A item records, and so on).

In some example embodiments, the network-based commerce system (e.g., the system 120 in FIG. 1) identifies (616) the first language associated with the search query.

FIG. 6B is a flow diagram further illustrating the method 600, in accordance with some example embodiments, for using semantic meaning vectors to perform single step search and translation. Each of the operations shown in FIG. 6B may correspond to instructions stored in a computer memory or computer-readable storage medium. Optional operations are indicated by dashed lines (e.g., boxes with dashed-line borders). In some embodiments, the method described in FIG. 6B is performed by the network-based commerce system (e.g., the system 120 in FIG. 1). However, the method described can also be performed by any other suitable configuration of electronic hardware.

In some embodiments the method 600 is performed at a network-based commerce system (e.g., the system 120 in FIG. 1) including one or more processors and memory storing one or more programs for execution by the one or more processors.

In some example embodiments, the network-based commerce system (e.g., the system 120 in FIG. 1) selects (618) a semantic meaning vector generation model associated with the identified first language. The network-based commerce system (e.g., the system 120 in FIG. 1) then uses the selected semantic meaning vector generation model to generate a semantic meaning vector for the search query.

In some example embodiments, the network-based commerce system (e.g., the system 120 in FIG. 1) accesses (622) a plurality of semantic meaning vectors associated with a plurality of item records, wherein at least some of the item records are not written in the first language. For example, the network-based commerce system (e.g., the system 120 in FIG. 1) stores a database of semantic meaning vectors associated with each item record that are created when the item record is submitted by a user.

In some example embodiments, the item records are written in a plurality of different languages. For example, the item records can include content using any language.

In some example embodiments, accessing a plurality of semantic meaning vectors associated with item records includes the network-based commerce system (e.g., the system 120 in FIG. 1) analyzing (624) the search query to identify one or more product categories associated with the search query. For example, the search query can be analyzed based on its text to narrow down the field of search.

In some example embodiments, the network-based commerce system (e.g., the system 120 in FIG. 1) accesses (626) semantic meaning vectors that are associated with the identified one or more product categories. In this way, the network-based commerce system (e.g., the system 120 in FIG. 1) can limit the number of semantic meaning vectors that it needs to consider when performing a search.

In some example embodiments, for each respective semantic meaning vector associated with an item records, the network-based commerce system (e.g., the system 120 in FIG. 1) compares (628) the respective semantic meaning vector with the semantic meaning vector associated with the search query. The comparison is to determine which item records are the best match to the search query.

In some example embodiments, comparing the respective semantic meaning vector with the semantic meaning vector associated with the search query further comprises the network-based commerce system (e.g., the system 120 in FIG. 1) calculating (630) a closeness score between the semantic meaning vector associated with the search query and the respective semantic meaning vector.

FIG. 6C is a flow diagram further illustrating the method 600, in accordance with some example embodiments, for using semantic meaning vectors to perform single step search and translation. Each of the operations shown in FIG. 6C may correspond to instructions stored in a computer memory or computer-readable storage medium. Optional operations are indicated by dashed lines (e.g., boxes with dashed-line borders). In some embodiments, the method described in FIG. 6C is performed by the network-based commerce system (e.g., the system 120 in FIG. 1). However, the method described can also be performed by any other suitable configuration of electronic hardware.

In some embodiments the method 600 is performed at a network-based commerce system (e.g., the system 120 in FIG. 1) including one or more processors and memory storing one or more programs for execution by the one or more processors.

In some example embodiments, the network-based commerce system (e.g., the system 120 in FIG. 1) ranks (632) the plurality of semantic meaning vectors based on the associated closeness scores. Thus, the semantic meaning vectors that are most relevant (or close in terms of semantic meaning vectors) are ranked highest.

In some example embodiments, the network-based commerce system (e.g., the system 120 in FIG. 1) selects (634) one or more item records based on the comparison between the semantic meaning vector associated with item records and the semantic meaning vector associated with the search query. In some example embodiments, the one or more item records are selected based at least in part on the ranking associated with each semantic meaning vector. In this way, the most relevant item records are selected.

For each respective selected item record, the network-based commerce system (e.g., the system 120 in FIG. 1) determines (636) whether the respective item record is written in the first language. For example, the network-based commerce system (e.g., the system 120 in FIG. 1) determines the language of the search query (e.g., Language 1) and the language of the respective item record and then compares them.

In accordance with a determination that the respective item record is not written in the first language, the network-based commerce system (e.g., the system 120 in FIG. 1) automatically translates (638) the respective item record into the first language. If the respective item record is written in the first language, no such translation is necessary, unless otherwise instructed by the user.

The network-based commerce system (e.g., the system 120 in FIG. 1) then transmits (640) the one or more selected item records to the client system (e.g., the client system 102 in FIG. 1) for display.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-6 are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

### Software Architecture

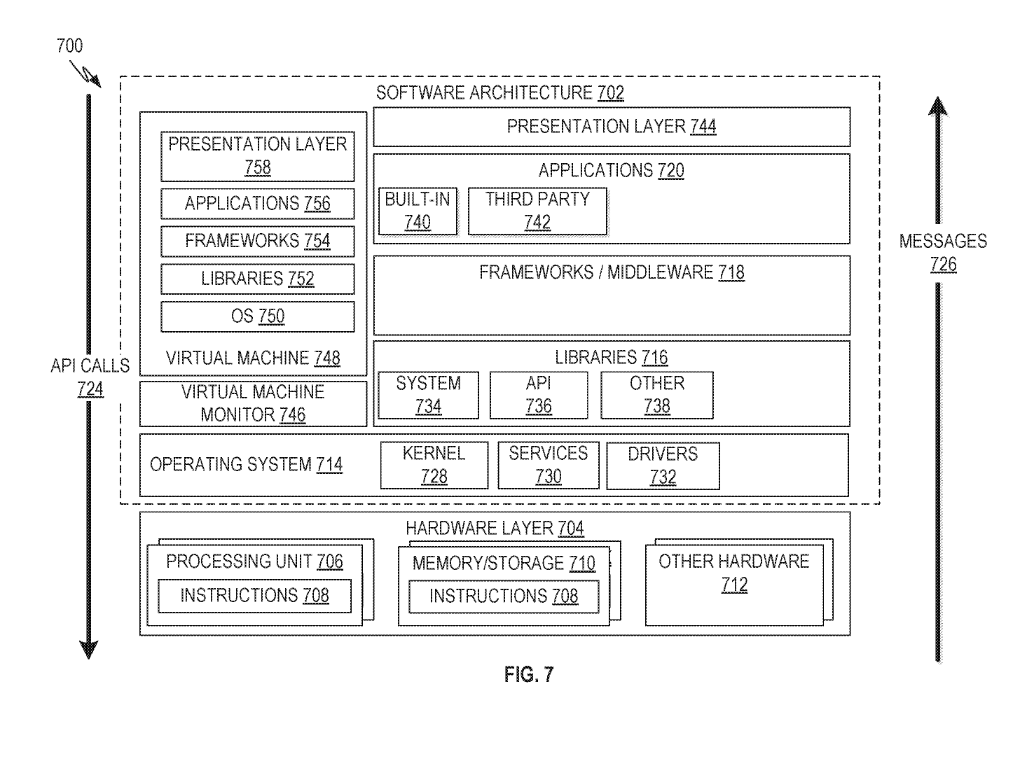

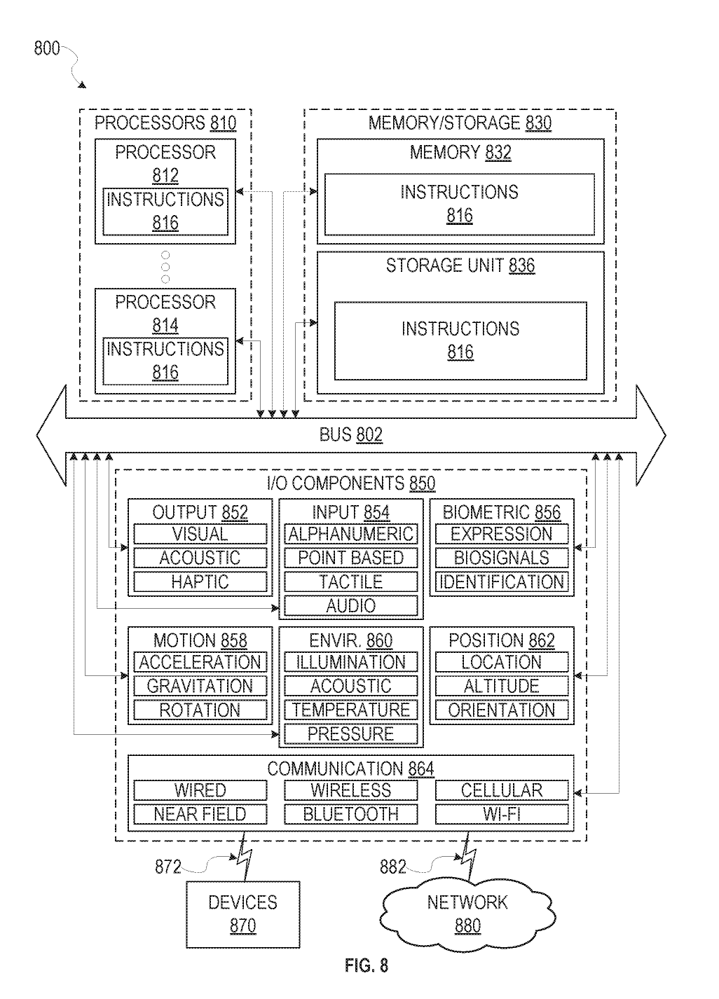

FIG. 7 is a block diagram 700 illustrating a representative software architecture 702, which may be used in conjunction with various hardware architectures herein described. FIG. 7 is merely a non-limiting example of a software architecture 702 and it will be appreciated that many other architectures may be implemented to facilitate the functionality described herein. The software architecture 702 may be executing on hardware such as a machine 800 of FIG. 8 that includes, among other things, processors 810, memory/storage 830, and I/O components 850. A representative hardware layer 704 is illustrated in FIG. 7 and can represent, for example, the machine 800 of FIG. 8. The representative hardware layer 704 comprises one or more processing units 706 having associated executable instructions 708. The executable instructions 708 represent the executable instructions of the software architecture 702, including implementation of the methods, modules, and so forth of FIGS. 1-6. The hardware layer 704 also includes memory and/or storage modules 710, which also have the executable instructions 708. The hardware layer 704 may also comprise other hardware 712, which represents any other hardware of the hardware layer 704, such as the other hardware illustrated as part of the machine 800.

In the example architecture of FIG. 7, the software architecture 702 may be conceptualized as a stack of layers where each layer provides particular functionality. For example, the software architecture 702 may include layers such as an operating system 714, libraries 716, frameworks/middleware 718, applications 720, and a presentation layer 744. Operationally, the applications 720 and/or other components within the layers may invoke application programming interface (API) calls 724 through the software stack and receive a response, returned values, and so forth, illustrated as messages 726, in response to the API calls 724. The layers illustrated are representative in nature and not all software architectures have all layers. For example, some mobile or special purpose operating systems may not provide a frameworks/middleware 718, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 716 may provide a common infrastructure that may be utilized by the applications 720 or other components or layers. The libraries 716 typically provide functionality that allows other software modules to perform tasks in an easier fashion than to interface directly with the underlying operating system 714 functionality (e.g., kernel 728, services 730, and/or drivers 732). The libraries 716 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks/middleware 718 may provide a higher-level common infrastructure that may be utilized by the applications 720 or other software components/modules. For example, the frameworks/middleware 718 may provide various graphic user interface (GUI) functions, high-level resource management, high-level location services, and so forth. The frameworks/middleware 718 may provide a broad spectrum of other APIs that may be utilized by the applications 720 or other software components/modules, some of which may be specific to a particular operating system or platform.

The applications 720 include built-in applications 740 or third party applications 742. Examples of representative built-in applications 740 may include, but are not limited to, a contacts application, a browser application, a book reader application, a location application, a media application, a messaging application, or a game application. The third party applications 742 may include any of the built in applications 740 as well as a broad assortment of other applications. In a specific example, the third party application 742 (e.g., an application developed using the Android™ or iOS™ software development kit (SDK) by an entity other than the vendor of the particular platform) may be mobile software running on a mobile operating system such as iOS™, Android™, Windows' Phone, or other mobile operating systems. In this example, the third party application 742 may invoke the API calls 724 provided by the mobile operating system such as the operating system 714 to facilitate functionality described herein.

The applications 720 may utilize built-in operating system functions (e.g., kernel 728, services 730, and/or drivers 732), libraries (e.g., system libraries 734, API libraries 736, and other libraries 738), and frameworks/middleware 718 to create user interfaces to interact with users of the system. Alternatively, or additionally, in some systems, interactions with a user may occur through a presentation layer, such as the presentation layer 744. In these systems, the application/module “logic” can be separated from the aspects of the application/module that interact with a user.

Some software architectures utilize virtual machines. In the example of FIG. 7, this is illustrated by a virtual machine 748. A virtual machine creates a software environment where applications/modules can execute as if they were executing on a hardware machine (e.g., the machine 800 of FIG. 8). A virtual machine is hosted by a host operating system (e.g., operating system 714) and typically, although not always, has a virtual machine monitor 746, which manages the operation of the virtual machine 748 as well as the interface with the host operating system (e.g., operating system 714). A software architecture executes within the virtual machine 748 such as an operating system 750, libraries 752, frameworks 754, applications 756, or presentation layer 758. These layers of software architecture executing within the virtual machine 748 can be the same as corresponding layers previously described or may be different.

### Example Machine Architecture and Machine-Readable Medium

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example, the instructions 816 may cause the machine 800 to execute the flow diagrams of FIGS. 5-6. The instructions 816 transform the general, non-programmed machine 800 into a particular machine programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory/storage 830, and I/O components 850, which may be configured to communicate with each other such as via a bus 802. In an example embodiment, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 812 and a processor 814 that may execute the instructions 816. The term “processor” is intended to include a multi-core processor that may comprise two or more independent processors (sometimes referred to as “cores”) that may execute the instructions 816 contemporaneously. Although FIG. 8 shows multiple processors 810, the machine 800 may include a single processor with a single core, a single processor with multiple cores (e.g., a multi-core processor), multiple processors with a single core, multiple processors with multiples cores, or any combination thereof.

The memory/storage 830 may include a memory 832, such as a main memory, or other memory storage, and a storage unit 836, both accessible to the processors 810 such as via the bus 802. The storage unit 836 and the memory 832 store the instructions 816 embodying any one or more of the methodologies or functions described herein. The instructions 816 may also reside, completely or partially, within the memory 832, within the storage unit 836, within at least one of the processors 810 (e.g., within the processor's cache memory), or any suitable combination thereof, during execution thereof by the machine 800. Accordingly, the memory 832, the storage unit 836, and the memory of the processors 810 are examples of machine-readable media.

As used herein, “machine-readable medium” means a device able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” should be taken to include a single medium or multiple media (e.g., a centralized or distributed database, or associated caches and servers) able to store the instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine 800 (e.g., processors 810), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 850 may include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion, and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environmental components 860, or position components 862 among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 862 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via a coupling 882 and a coupling 872 respectively. For example, the communication components 864 may include a network interface component or other suitable device to interface with the network 880. In further examples, the communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a Universal Serial Bus (USB)).

Moreover, the communication components 864 may detect identifiers or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geo-location, location via Wi-Fi® signal triangulation, location via detecting an NFC beacon signal that may indicate a particular location, and so forth.

### Transmission Medium

In various example embodiments, one or more portions of the network 880 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., hypertext transfer protocol (HTTP)). Similarly, the instructions 816 may be transmitted or received using a transmission medium via the coupling 872 (e.g., a peer-to-peer coupling) to the devices 870. The term “transmission medium” shall be taken to include any intangible medium that is capable of storing, encoding, or carrying the instructions 816 for execution by the machine 800, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving a search query in a first language from a client system;
generating a semantic meaning vector associated with the search query;
accessing a plurality of semantic meaning vectors associated with a plurality of item records, wherein at least some of the item records are not written in the first language;
for each respective semantic meaning vector associated with item records:
comparing the respective semantic meaning vector with the semantic meaning vector associated with the search query;
selecting one or more item records based on the comparison between the semantic meaning vector associated with the item records and the semantic meaning vector associated with the search query;
for each respective selected item record:
determining whether the respective item record is written in the first language; and
in accordance with a determination that the respective item record is not written in the first language, automatically translating the respective item record into the first language; and
transmitting the one or more selected item records to the client system for display.

2. The method of claim 1, wherein the item records are written in a plurality of different languages.

3. The method of claim 1, further comprising:
receiving an item record for inclusion in a network-based commerce system;
generating a semantic meaning vector for the received item record; and
storing the semantic meaning vector in a database at the network-based commerce system.

4. The method of claim 3, wherein the storing the semantic meaning vector further comprises:
analyzing the item record associated with the semantic meaning vector to identify a product category associated with the semantic meaning vector, and
organizing the database such that each semantic meaning vector is associated with the determined product category.

5. The method of claim 1, wherein comparing the respective semantic meaning vector with the semantic meaning vector associated with the search query further comprises:
calculating a closeness score between the semantic meaning vector associated with the search query and the respective semantic meaning vector.

6. The method of claim 5, further comprising ranking the plurality of semantic meaning vectors based on the calculated closeness scores.

7. The method of claim 6, wherein the one or more item records are selected based at least in part on the ranking associated with each semantic meaning vector.

8. The method of claim 4, wherein accessing the plurality of semantic meaning vectors associated with the plurality of item records further comprises:
analyzing the search query to identify one or more product categories associated with the search query; and
accessing semantic meaning vectors that are associated with the identified one or more product categories.

9. The method of claim 1, wherein generating the semantic meaning vector associated with the search query further comprises:
identifying the first language associated with the search query;
selecting a semantic meaning vector generation model associated with the identified first language; and
using the selected semantic meaning vector generation model to generate a semantic meaning vector for the search query.

10. A system comprising:
one or more processors;
memory; and
one or more programs stored in the memory, the one or more programs comprising instructions for:
receiving a search query in a first language from a client system;
generating a semantic meaning vector associated with the search query;
accessing a plurality of semantic meaning vectors associated with a plurality of item records, wherein at least some of the item records are not written in the first language;
for each respective semantic meaning vector associated with item records:
comparing the respective semantic meaning vector with the semantic meaning vector associated with the search query;
selecting one or more item records based on the comparison between the semantic meaning vector associated with the item records and the semantic meaning vector associated with the search query;
for each respective selected item record:
determining whether the respective item record is written in the first language; and
in accordance with a determination that the respective item record is not written in the first language, automatically translating the respective item record into the first language; and
transmitting the one or more selected item records to the client system for display.

11. The system of claim 10, wherein the item records are written in a plurality of different languages.

12. The system of claim 10, further comprising:
receiving an item record for inclusion in a network-based commerce system;
generating a semantic meaning vector for the received item record; and
storing the semantic meaning vector in a database at the network-based commerce system.

13. The system of claim 12, wherein the storing the semantic meaning vector further comprises:
analyzing the item record associated with the semantic meaning vector to identify a product category associated with the semantic meaning vector; and
organizing the database such that each semantic meaning vector is associated with the determined product category.

14. The system of claim 10, wherein comparing the respective semantic meaning vector with the semantic meaning vector associated with the search query further comprises:
calculating a closeness score between the semantic meaning vector associated with the search query and the respective semantic meaning vector.

15. The system of claim 14, further comprising ranking the plurality of semantic meaning vectors based on the calculated closeness scores.

16. A non-transitory computer-readable storage medium storing instructions that, when executed by the one or more processors of a machine, cause the machine to perform operations comprising:
receiving a search query in a first language from a client system;
generating a semantic meaning vector associated with the search query;
accessing a plurality of semantic meaning vectors associated with a plurality of item records, wherein at least some of the item records are not written in the first language;
for each respective semantic meaning vector associated with item records:
comparing the respective semantic meaning vector with the semantic meaning vector associated with the search query;
selecting one or more item records based on the comparison between the semantic meaning vector associated with the item records and the semantic meaning vector associated with the search query;
for each respective selected item record:
determining whether the respective item record is written in the first language; and
in accordance with a determination that the respective item record is not written in the first language, automatically translating the respective item record into the first language; and
transmitting the one or more selected item records to the client system for display.

17. The non-transitory computer-readable storage medium of claim 16, wherein the item records are written in a plurality of different languages.

18. The non-transitory computer-readable storage medium of claim 16, further comprising:
receiving an item record for inclusion in a network-based commerce system;
generating a semantic meaning vector for the received item record; and
storing the semantic meaning vector in a database at the network-based commerce system.

19. The non-transitory computer-readable storage medium of claim 18, wherein the storing the semantic meaning vector further comprises:
analyzing the item record associated with the semantic meaning vector to identify a product category associated with the semantic meaning vector; and
organizing the database such that each semantic meaning vector is associated with the determined product category.

20. The non-transitory computer-readable storage medium of claim 16, wherein comparing the respective semantic meaning vector with the semantic meaning vector associated with the search query further comprises:
calculating a closeness score between the semantic meaning vector associated with the search query and the respective semantic meaning vector.
